(19) United States
(12) Patent Application Publication
(10) Pub. No.: US 2008/0084182 A1
(43) Pub. Date: Apr. 10, 2008

(54) Lithium battery system

(75) Inventors: Richard Paul Oberlin, Phoenix, MD (US); James Paul Blatt, Lutherville, MD (US)

Correspondence Address: VENABLE LLP, P.O. BOX 34385, WASHINGTON, DC, 20043-9998, US

(73) Assignee: AAI Corporation, Hunt Valley, MD (US)

(21) Appl. No.: 11/543,894

(22) Filed: Oct. 6, 2006

(51) Int. Cl. H02J 7/00

(52) U.S. Cl. 320/116

(57) ABSTRACT

A lithium battery system for providing power to a load and a method for controlling the same. The system includes an alternator and a battery pack coupled in parallel with the alternator and the load via a vehicle voltage bus. The battery pack includes a lithium battery having a plurality of cells connected to the vehicle voltage bus to filter noise thereon and a battery management system coupled to the lithium battery. The battery management system is configured to vary a voltage output of the alternator based on a voltage and/or a current of the lithium battery. The noise along the vehicle voltage bus is reduced by the placement of the lithium battery.

### BACKGROUND OF THE INVENTION

1. Field of the Invention

The present invention relates generally to a lithium battery system, and more particularly to a lithium battery system for use in a vehicle such as, for example, an unmanned aerial vehicle (“UAV”). Filtering of noise and transients is provided by the lithium battery.

2. Related Art

Lightweight UAVs are becoming popular for various uses including surveillance and package delivery in military and law enforcement endeavors. Such UAVs typically include an engine for powering the flight of the UAV, as well as a battery and alternator/generator arrangement connected to a vehicle bus to provide electrical power to one or more onboard electronic operating loads. In operation, the alternator/generator charges the battery. Depending on the particular operating conditions, at least one of the battery and alternator/generator supplies power to the load.

Generally, lead acid batteries have been used in the foregoing arrangement. A conventional battery regulator is also included to control the alternator/generator field current. Lead acid batteries are practical in this regard because they tolerate a wide range of charging conditions and can be overcharged without the risk of damage or explosion. For example, when a lead acid battery is overcharged it breaks up water into oxygen and hydrogen. In closed cells, a catalyst is used to recombine the oxygen and hydrogen back into water. In open cells, the oxygen and hydrogen are vented to the atmosphere. Thus, no precautions need be taken to make sure that all lead acid battery cells in a series are charged properly (i.e., fully charged or charged at the same rate) so long as care is taken in open cells to avoid igniting the vented hydrogen produced during charging.

FIG. 1 is a schematic representation of a conventional lead acid battery and alternator/generator arrangement 10. A lead acid battery 12 is connected to a vehicle voltage bus 11. Additionally, a lead acid regulator 13 and an alternator/generator 14 are connected to the vehicle voltage bus 11, the lead acid regulator 13 being configured to regulate charging of the lead acid battery 12 by controlling the alternator/generator 14 field current. At least one load 15 is also connected to the vehicle voltage bus 11 to receive power supplied by at least one of the alternator/generator 14 and the lead acid battery 12, depending upon operating conditions.

For example, when the alternator/generator 14 is operative, it supplies power to the load 15 and simultaneously charges the lead acid battery 12. Charging of the lead acid battery 12 is typically performed by initially providing a high constant current to the lead acid battery 12, and then reducing the current to some smaller maintenance value as the lead acid battery 12 reaches a fully-charged state. Alternatively, when the alternator/generator 14 is not operative, the lead acid battery 12 provides all of the power to the load 15. Battery voltage can be, for example, as low as 9 volts and as high as 16 volts for a nominal 12 volt lead acid battery 12, the load 15 being capable of accommodating such a voltage range. A fuse or circuit breaker (not shown) is usually provided for each load since lead acid batteries can, in certain instances, output large currents under short circuit situations. Without such precautions, such short circuit situations can result in melted wires and/or a fire.

A further advantage that results from placing the lead acid battery 12 directly across the vehicle voltage bus 11 is that it can effectively serve the function of a large capacitor (e.g., up to several Farads) by filtering noise created by the lead acid regulator 13, alternator/generator 14, and/or load 15.

Lithium batteries, on the other hand, provide a significantly higher energy density than lead acid batteries and are, therefore, better suited for lightweight applications requiring a sustainable energy source. Specifically, a lithium battery can provide approximately three to four times the amount of energy provided by a lead acid battery under the same space and weight limitations. FIG. 2 schematically depicts a conventional lithium battery configuration 20. A vehicle voltage bus 11 is provided having a load 15, an alternator unit 21, and a lithium battery unit 22 connected thereto.

The lithium battery unit 22 includes a lithium battery 24 connected to the vehicle voltage bus 11 through a battery protection element 25. The alternator unit 21 includes an alternator/generator regulator 23 and alternator/generator 14, the alternator/generator regulator 23 regulating the voltage on the vehicle voltage bus 11 by controlling the alternator/generator 14 field current. The lithium battery 24 is charged from the vehicle voltage bus 11 through the battery protection element 25.

The load 15 receives power supplied by at least one of the alternator/generator 14 and the lithium battery 24, depending upon operating conditions. For example, when the alternator/generator 14 is operative, it supplies power to the load 15 and simultaneously charges the lithium battery 24. Charging of the lithium battery 24, as controlled by the battery protection element 25, is typically performed by providing a high constant current to the lithium battery 24 which transitions to constant voltage as the lithium battery 24 reaches a fully-charged state. Alternatively, when the alternator/generator 14 is not operative, the lithium battery 24 provides all of the power to the load 15. Battery voltage can be, for example, as low as 9 volts and as high as 14.7 volts for a nominal 12 volt lithium battery 24, the load 15 being capable of accommodating such a voltage range.

Despite the foregoing advantages, lithium batteries are not tolerant to overcharge and precautions must be taken to make sure that all cells in series are charged properly. For instance, when a lithium cell is overcharged, metallic lithium is plated out. Metallic lithium is highly reactive to water and a fire or explosion can easily result. Additionally, lithium batteries can put out very large currents under short circuit situations which can result in melted wires and/or fire. Thus, although fuses and/or circuit breakers are typically placed on individual loads to prevent such situations, a battery protection element 25 is generally required to monitor each cell of the lithium battery 24. The battery protection element 25 will, for example, monitor the current being drawn by the lithium battery 24 and disconnect the lithium battery 24 if the current exceeds some predetermined value.

The conventional lithium battery configuration 20 has several other disadvantages. First, because the alternator/generator 14 and the alternator/generator regulator 23 operate independently of the lithium battery 24 and the battery protection element 25, this leads to power inefficiencies. Second, in order to perform its intended function of regulating each cell of the lithium battery 24, the battery protection element 25 is placed between the lithium battery 24 and the vehicle voltage bus 11 such that the lithium battery 24 cannot perform the noise filtering function discussed above with regard to the lead acid arrangement 10 (FIG. 1). Therefore, the noise on the vehicle voltage bus 11 from the alternator/generator 14 and alternator/generator regulator 23 is significantly higher than in the lead acid arrangement 10.

In order to solve the shortcomings resulting from the conventional lithium battery configuration 20, and to provide additional energy capacity, it has been proposed (FIG. 3) to additionally include a supplemental lead acid battery 12 in a lead acid/lithium battery and alternator arrangement 30. The lead acid/lithium battery and alternator arrangement 30 functions substantially similar to the conventional lithium battery configuration 20 except that the supplemental lead acid battery 12 is included across the vehicle voltage bus 11 to filter noise from the lead acid regulator 13, alternator/generator 14, and the load 15.

Nevertheless, as similarly noted above with respect to the configuration shown in FIG. 2, the supplemental lead acid battery 12, the alternator/generator 14, and the lead acid regulator 13 operate independently of the lithium battery 24 and the battery protection element 25 in a separate lead acid/alternator unit 31, which again leads to power inefficiencies. In addition, the supplemental lead acid battery 12 means increased weight and/or reduced size of the lithium battery 24.

A lithium battery configuration is, therefore, needed that overcomes the above-described problems. Particularly, a lithium battery configuration is needed that provides direct control of the alternator/generator field current so that the lithium battery can be properly charged without the need for a separate alternator/generator regulator. Furthermore, a lithium battery configuration is needed that simultaneously provides buffering along the vehicle voltage bus to filter noise and transients.

### BRIEF SUMMARY OF THE INVENTION

An exemplary embodiment of the present invention provides a battery pack for a lithium battery system. The battery pack includes a lithium battery having a plurality of cells connectable to a vehicle voltage bus to filter noise thereon. The battery pack further includes a battery management system coupled to the lithium battery and being configured to vary a voltage output of an alternator based on a current and/or voltage of the lithium battery when the battery pack is connected to the vehicle voltage bus.

In another exemplary embodiment of the invention, a lithium battery system is described. The system includes the afore-mentioned battery unit coupled in parallel with an alternator and a load via a vehicle voltage bus. The lithium battery of the battery unit is connected to the vehicle voltage bus to provide filtering of noise and transients thereon.

The present invention also provides a method of controlling the lithium battery system including the steps of connecting the lithium battery to the vehicle voltage bus to filter noise thereon, measuring a voltage and/or a current of the lithium battery during charging, and varying the voltage output of the alternator based on the voltage and/or the current of the lithium battery.

Further objectives and advantages, as well as the structure and function of exemplary embodiments will become apparent from a consideration of the description, drawings, and examples.

### BRIEF DESCRIPTION OF THE DRAWINGS

The foregoing and other features and advantages of the invention will be apparent from the following, more particular description of exemplary embodiments of the invention, as illustrated in the accompanying drawings wherein like reference numbers generally indicate identical, functionally similar, and/or structurally similar elements.

FIG. 1 depicts a schematic representation of a conventional lead acid battery and alternator/generator arrangement;

FIG. 2 schematically depicts a conventional lithium battery and alternator/generator arrangement;

FIG. 3 schematically depicts a conventional lead acid/lithium battery arrangement;

FIG. 4 schematically depicts a lithium battery system in accordance with an exemplary embodiment of the present invention; and

FIG. 5 is a more detailed schematic depiction of the lithium battery system of FIG. 4.

FIG. 6 is a more detailed schematic depiction of the battery pack of FIG. 4.

### DETAILED DESCRIPTION OF THE INVENTION

Exemplary embodiments of the invention are discussed in detail below. In describing embodiments, specific terminology is employed for the sake of clarity. However, the invention is not intended to be limited to the specific terminology so selected. While specific exemplary embodiments are discussed, it should be understood that this is done for illustration purposes only. A person skilled in the relevant art will recognize that other components and configurations can be used without departing from the spirit and scope of the invention.

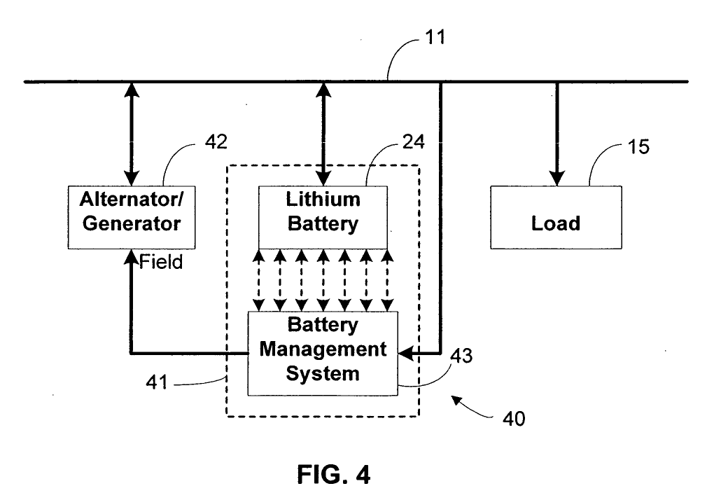

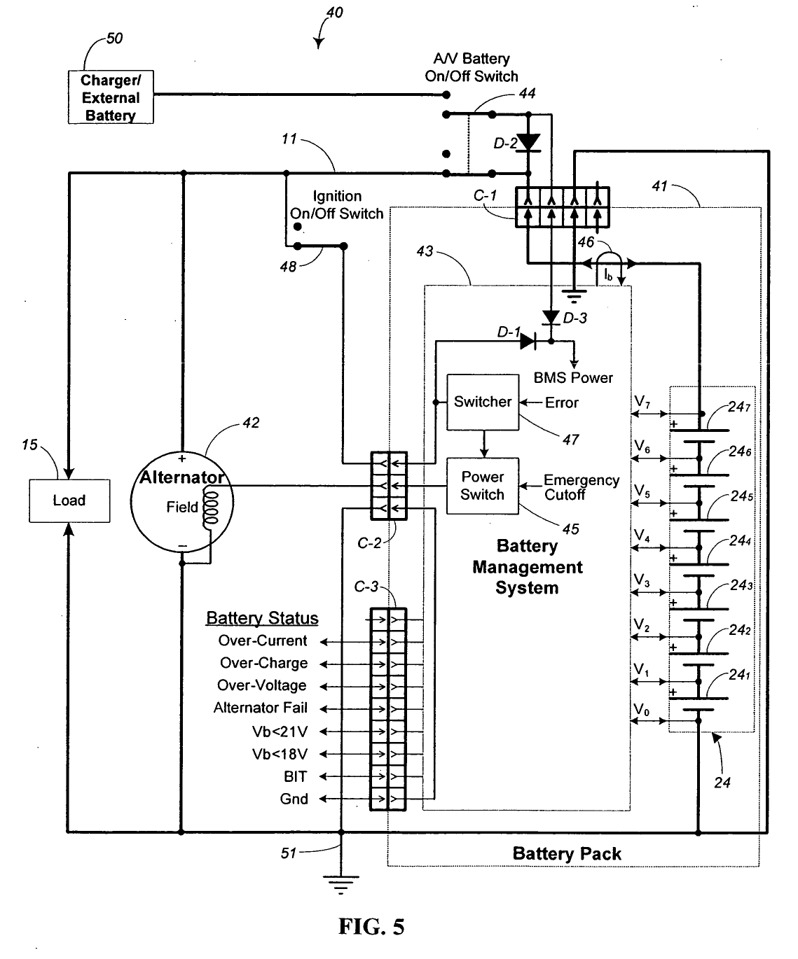

FIG. 4 schematically depicts a lithium battery system 40 in accordance with an exemplary embodiment of the present invention. Referring to FIG. 4, the lithium battery system 40 includes a battery pack 41 coupled to an alternator/generator 42 and a load 15 on a vehicle voltage bus 11. The battery pack 41 can include a lithium battery 24 and a battery management system 43 configured to control charging of the lithium battery 24 by monitoring a charge state of the lithium battery and regulating a field current of the alternator/generator 42. The lithium battery 24 is coupled directly to the voltage bus 11 to buffer noise.

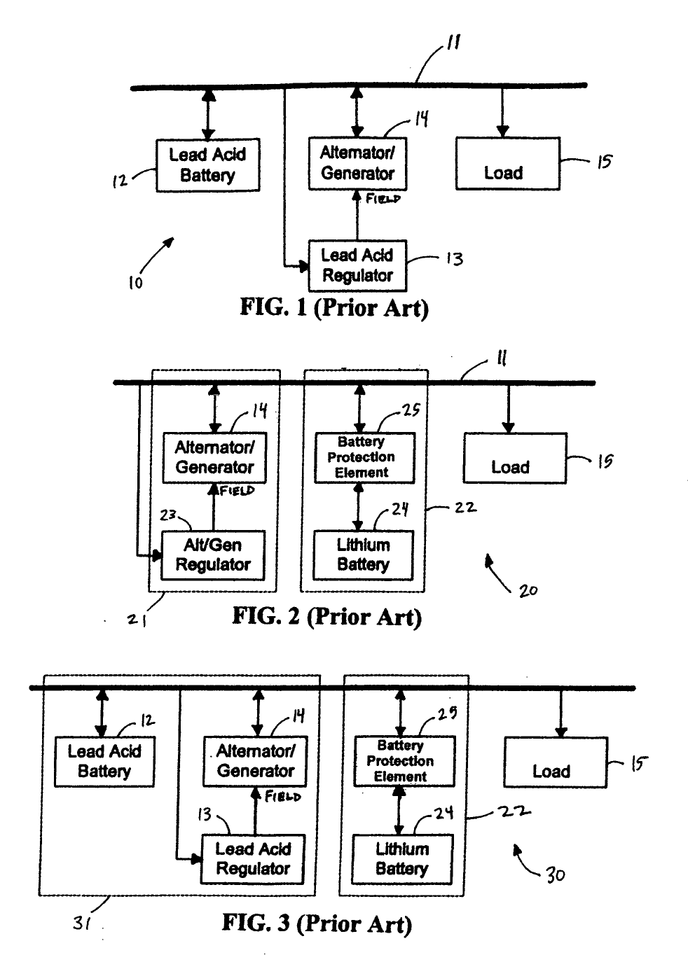

FIG. 5 is a more detailed schematic depiction of the lithium battery system 40 of FIG. 4 for use in a vehicle such as, for example, a UAV. Referring to FIG. 5, the lithium battery system 40 can include the battery pack 41 coupled in parallel with the alternator 42 and the load 15 between the vehicle voltage bus 11 and a voltage reference point 51. Alternator 42 can be coupled to an engine of the vehicle (not shown) to provide electrical power to the load 15 and the lithium battery 24 when the engine is running. The lithium battery 24 can be, for example, a lithium-ion battery. The lithium battery system 40 thus provides the above-described functions as well as extended battery operating capacity and reduced space and weight requirements in comparison to conventional lead acid battery arrangements (FIG. 1) or lithium/lead acid configurations (FIG. 3).

The battery pack 41 includes the lithium battery 24 having a plurality of cells or cell rows 24₁-24ₙ connected in series between the vehicle voltage bus 11 and ground. The plurality of lithium cells 24₁-24ₙ may be, for example, seven lithium-ion cells 24₁-24₇ arranged in series. The lithium cells 24₁-24ₙ do not energize the load 15 while the alternator 42 is operative, but rather, the battery 24 provides auxiliary power to the load 15 in the event of an alternator failure. The battery pack 41 further includes the battery management system 43 to control charging of the lithium battery 24. According to this embodiment, and as compared with the conventional lithium battery configuration 20 depicted in FIG. 2, the battery management system 43 is not in series with the lithium battery 24 and therefore, the lithium battery 24 which is connected between the vehicle voltage bus 11 and ground, functions to filter noise and transients produced by the alternator 42, the load 15, or other source.

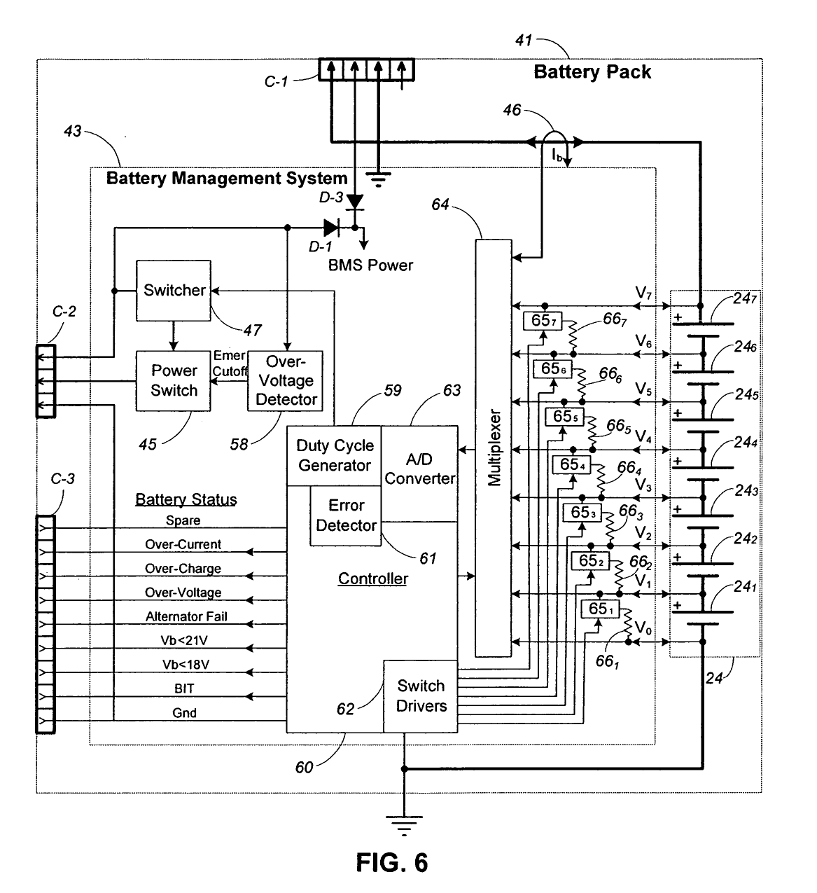

The plurality of lithium cells 24₁-24ₙ must be monitored closely and balanced during charging to avoid overcharge and plating out of highly-reactive metallic lithium. The battery management system 43 controls charging of the lithium battery 24 by controlling the field current of the alternator 42 based on the battery current and/or the battery voltage. The battery management system 43 can further control charging of the lithium battery 24 on a cell by cell (or cell row by cell row) basis based on charge conditions. For this purpose, the battery management system 43 is provided with a current shunting device (see FIG. 6) for each lithium cell or cell row 24₁-24ₙ. Non-limiting examples of current shunting devices include, for example, MOSFETs, transistors, switched resistors, optical devices. In one embodiment, for example, a 40 ohm resistor 66₁-66₇ (see FIG. 6) may be switched in or out across each, cell or cell row 24₁-24ₙ. During charging, when a predetermined voltage level is exceeded across one cell relative to the other cells (e.g., lithium ion cells are typically balanced to within +/0.1VDC between cells at cell voltages greater than 3.9VDC), the battery management system 43 can switch a shunting resistor across the cell exhibiting an over-voltage condition to reduce that row's charging rate and to balance the charging on a cell by cell basis by slowing down fast cells and letting the slower ones catch-up. The amount of shunted current (and, therefore, the resistance value if a fixed resistor is used) and the predetermined voltage level are a function of a given cell type and are typically specified by the cell's manufacturer. Since the terminal voltage of a lithium cell increases as the cell is charged (and decreases as it is discharged), the battery management system 43 can further vary the alternator field current to prevent over-current or over-voltage conditions in the remaining cells. This only slightly affects charging efficiency. Depending on the relative characteristics of the cells, more than one cell may have its current shunted at one time up to the point that only one cell (if it is slower to charge than all the rest) may be receiving full charge current. As the slower cells catch up, the shunting current may be fully or partially removed from the faster charging cells by the battery management system 43. When the final end charging point is reached (typically this would be an average of 4.2V for a lithium ion cell times the number of cells), no further charging can take place since the field current of the alternator 42 is controlled by the battery management system 43 to not exceed that voltage (for example, 29.4V for a 7 cell lithium ion battery). At that point all current shunting is terminated by the battery management system 43. Due to tolerances, final cell voltage levels may vary from, for example, 4.1V to 4.3V, but the sum will be 29.4V. The tolerance of +/−0.1V in the exemplary embodiment is arbitrary and can be set by a designer depending on the accuracy (and cost) of the components selected.

The battery management system 43 may also monitor the temperature of each lithium cell 24₁-24ₙ to determine temperature-corrected charge levels for each lithium cell 24₁-24ₙ. Additionally, if a predetermined temperature (e.g., 150° C.) is exceeded in a cell, the battery management system 43 decreases the charge rate of that cell by shunting current around that cell as discussed previously. If the cell that is over-temperature does not cool down to less than the maximum temperature (e.g., 150° C.), in a preset time, the battery management system 43 will decrease the output voltage 11 of the alternator 42, and thus the overall battery charging current, by lowering the alternator field current periodically until cell temperature recovery is evident. Normally the charging currents are not high enough for temperature to be a concern during charging.

The battery management system 43 may be implemented as software executed by a micro-processor controller described further below (see also FIG. 6). Additionally, the battery management system 43 may be a digital-based system or an analog-based system, and/or may be embedded in hardware, coded, or written into application or operating system software in a PC-based or other hardware system.

Embodiments of the invention may be implemented in one or a combination of hardware, firmware, and software. Embodiments of the invention may also be implemented as instructions or algorithms stored on a machine-accessible medium, which may be read and executed by a computing platform to perform the operations described herein. A machine-accessible medium may include any mechanism for storing or transmitting information in a form readable by a machine (e.g., a computer). For example, a machine-accessible medium may include read only memory (ROM); random access memory (RAM); magnetic disk storage media; optical storage media; flash memory devices; electrical, optical, acoustical, or other form of propagated signals (e.g., carrier waves, infrared signals, digital signals, etc.), and others.

The battery management system 43 further includes a power switch 45, a current sensor 46 for measuring battery current, and an alternator field current switcher 47. The power switch 45 is, for example, a low-on resistance, high power MOSFET which transmits a variable field current from the switcher 47 to the alternator 42 through connector C-2 and also removes the alternator field current in the event of a high field current malfunction of the battery management system 43. Current being drawn by the lithium battery 24 is monitored by the current sensor 46 such as, for example, a Hall Effect sensor, to keep the sensor voltage drop low. The alternator field current switcher 47 is coupled to the alternator 42 through power switch 45 and is configured to supply a variable field current to control the output current of the alternator 42. In this way, the battery management system 43 can control charging of the lithium battery 24 in a constant current/constant voltage manner.

For example, when the lithium battery 24 is at least partially discharged, the battery management system 43 can detect this by measuring the battery charging current and/or the battery voltage. The battery management system 43 then commands a predetermined maximum charging current by varying the alternator field current until such time as a fully charged state is reached and the battery charging current is dropped to zero. At times, the battery charging current may be limited to less than the predetermined maximum battery charging current due to the load 15 and/or the output capability of the alternator 42 (e.g., when the vehicle engine is running at low RPM). In this case, the battery management system 43 simply commands a maximum possible charging current by applying full field current to the alternator 42. When the battery management system 43 detects a failure of alternator 42 by monitoring the battery current, the battery management system 43 terminates the alternator field current. For example, in the exemplary embodiment, the battery management system 43 contains a controller 60 (not shown in FIG. 5, but described in further detail below with reference to FIG. 6) such as, for example, a microprocessor or a linear amplifier system, arranged to monitor the battery current, both charge and discharge, via current sensor 46. The controller 60 compares the monitored charge current, from sensor 46, to the charge current limit programmed or preset into the battery management system 43. If the actual charging current is below this limit, giving a negative error value, the controller 60 increases the switcher 47 “On” period or duty cycle (or increases MOSFET conduction if a linear approach is used) proportionally to the error signal until the average charging current approaches the charge current limit. If, on the other hand, the actual charging current is above the limit programmed or preset into the battery management system 43, giving a positive error value, the controller 60 decreases the switcher 47 “On” period or duty cycle (or decreases MOSFET conduction if a linear approach is used) proportionally to the error signal until the average charging current approaches the charge current limit, or typically goes just below it. As the battery 24 approaches a preprogrammed maximum voltage (indicating full charge), the difference between the battery voltage and the preprogrammed voltage limit is used as the error signal and the switcher 47 “On” period or duty cycle (or MOSFET conduction) is used to keep the battery voltage at or near the preprogrammed maximum voltage limit.

The battery management system 43 is powered by the alternator 42 when the ignition switch 48 and A/V battery switch 44 are both in the positions shown in FIG. 5 (i.e., the engine is running). In this operating condition, current will flow through a connector C-2 and a diode D-1 from the bus 11 to the battery management system 43. This will be the case when a UAV incorporating the lithium battery and alternator arrangement 40 is operational. Alternatively, when the ignition switch 48 is open and the A/V battery switch 44 is connected to the charging/external battery 50 (i.e., the engine is not running), the lithium battery 24 can still be charged by the charger/external battery 50. In this operating condition, current will flow through a diode D-2 and a connector C-1 to charge the lithium battery 24; current will also flow through a diode D-3 and the connector C-1 to power the battery management system 43. This will be the case when a UAV incorporating the lithium battery system 40 is not operational.

The battery pack 41, including battery management system 43, is shown in more detail in FIG. 6. The exemplary embodiment shown is based on a micro-processor controller 60 but could also be accomplished with discrete circuitry using analog, digital or a combination of analog and digital. The controller 60, as shown in FIG. 6, is capable of several internal functions that are consistent with general purpose micro-processors. The details of the program and arithmetic portion are not shown or described. The battery management system 43 may include a multiplexer 64 arranged to receive analog signals from the current sensor 46 as well as from each of the cells 24₁-24ₙ. The multiplexer 64 may be configured to sequence through the incoming analog signals one at a time as directed by the controller 60. Controller 60 may include an A/D (Analog to Digital) converter portion 63 to convert incoming analog signals to digital so that the controller 60 can operate on them in the digital domain. The incoming signals may be, for example, seven cell voltages, V₁ to V₇, and the battery current (both charge and discharge) as determined by the battery current sensor 46. Once the incoming signals are in digital form, the controller 60 may run its internal program to determine the cell status such as charge state and balance. The internal program may contain, for example, two preprogrammed limits, a preprogrammed charge current limit such as, for example, 10 amperes, and a preprogrammed charge voltage limit such as, for example, 29.4 volts. From this, the controller 60 can determine whether any cells are charging too fast and what the charge current or charge voltage should be. The controller 60 may then activate appropriate solid state switches 65₁ to 65₇ via switch drivers 62 to shunt some charge current around the fast charging cell or cells by switching respective shunting resistors 66₁ to 66₇ thereacross. The controller 60 can compare the charging current (as determined by the battery current sensor 46 and as converted to digital through the multiplexer 64 and the A/D converter 63) against the preprogrammed charge current limit. The charging current error may be determined by an error detection function 61 of controller 60 by subtracting the actual charging current from the programmed charge current limit. The error is used to proportionately change an “On” time or on/off duty cycle of a duty cycle generator 59 of controller 60. The output of the duty cycle generator 59 may be applied to the switcher 47 to adjust the average field current going to the alternator 42 (see FIG. 5) to obtain the desired charge current.

The controller 60 may also compare the A/V bus voltage against the programmed charge voltage limit and, if it is equal to or above this limit, charging is terminated and this includes opening all the switches 65₁ to 65₇ thus removing any and all shunting resistors 66₁ to 66₇. If the A/V bus voltage is below but near this limit, the error is determined by the error detection function 61 inside controller 60 by subtracting the A/V bus voltage from the programmed charge voltage limit. If the A/V bus voltage is within a given tolerance of the programmed charge voltage limit such as, for example, 0.5 volt, the charge voltage error is substituted for the charge current error by controller 60 and the resulting duty cycle as determined by the duty cycle generator 59 is used to control the switcher 47 to adjust the average alternator field current to keep the A/V bus voltage at the programmed charge voltage limit.

In one exemplary embodiment of the above-described lithium battery system 40, the following values and characteristics provided advantageous results. On a 28 VDC bus 11, the battery 24 includes seven 4.2 VDC lithium-ion cells 24₁-24₇ arranged in series and having an operating range of 29.4 VDC at a fully charged state down to 21 VDC at a rated discharge level. The vehicle load 15 has an operating range of 32 VDC down to 18 VDC such that the load 15 requirement is satisfied so long as the lithium battery 24 is providing power within the foregoing operating range. The lithium battery 24 is allowed to drop to 18 VDC under emergency conditions. Maximum battery charging current is set to approximately 30 amps (+/−2 amps) and alternator 42 is configured to output from 0-50 amps. The battery management system 43 is rated for 32 VDC without the lithium battery 24 connected. The shunting resistors (not shown) employed in the battery management system 43 when one or more of the lithium cells 24₁-24₇ are charging faster than the others (e.g., more than 0.1 V higher) are determined by the cell characteristics and, in the exemplary embodiment discussed herein, are 40 ohm resistors.

The alternator field current switcher 47 is configured to provide from about 0-4 amps field current to the alternator 42 depending upon the battery charging level measured by the battery management system 43. The switcher 47 has less than a 0.1 VDC drop across it with 4 amps field current flowing through it at 100% duty cycle. The switcher 47 further operates at a frequency of 10 KHz or higher to prevent putting increased alternator noise on the 28 VDC line 11, and preferably between 20-25 KHz.

In the foregoing embodiment, the total weight of the battery pack 41, including the seven lithium-ion cells 24₁-24₇, a tray for the cells, and the battery management system 43, is approximately 8.0 lbs (where 7.6 lbs are attributed to the lithium-ion cells 24₁-24₇ and the tray).

As generally shown in FIGS. 5 and 6, the battery management system 43 may further output at least six status signals via connector C-3 based on the operating condition of the lithium battery and alternator arrangement 40. The at least six status signals are all at a low TTL level during normal operation as provided above. The first status signal indicates an over-current state wherein the battery charging current detected by the current sensor 46 of the battery management system 43 exceeds 30A by 10% or more. Likewise, the second status signal indicates an over-charge state wherein the battery management system 43 detects that one or more of the lithium cells 24₁-24ₙ exceeds full charge (4.2VDC) by more than a nominal 0.2 VDC. When either one of these conditions occur, the battery management system 43 sets the over-current status or the over-charge status, respectively, to a high TTL level and disconnects the alternator field current by switching off power switch 45. This condition can arise when control of the alternator field current by the battery management system 43 fails. In this situation, the battery 24 remains connected to the bus 11 and supplies power to the load 15. The battery management system 43 will not reactivate the power switch 45 until the battery voltage drops below 24 VDC.

The third status signal indicates an over-voltage state which may result when the battery on/off switch 44 is connected to the charger/external battery 50 and the running engine is providing power to the battery management system 43 via closed switch 48. Under this condition, the battery management system 43 is able to operate without damage up to 32 VDC without the battery connected to the alternator 42. Above 32 VDC (and up to 60 VDC), however, the battery management system 43 is configured to power off (via the emergency cutoff) to avoid permanent damage.

The fourth status signal indicates an alternator fail state when no usable electrical output from the alternator 42 is detected. The battery management system 43 determines this state by monitoring the battery charging current with the current sensor 46. When the battery charging current is in the discharge direction for 30 consecutive seconds or more, the battery management system 43 sets the “alternator fail” status signal to a high TTL and sets the alternator field current to zero.

The fifth status signal indicates an under-voltage state wherein when the total voltage across the lithium battery 24 drops to 21 VDC or lower, the battery management system 43 sets the “Vb<21 VDC” status to a high TTL level. Similarly, when the total voltage across the lithium battery 24 drops to 18 VDC or lower, the battery management system 43 sets the sixth status signal, “Vb<18 VDC,” to a high TTL level.

The battery management system 43 may further include a Built-In-Test (BIT) serial link that sends out and/or is interrogated as to the health of the battery 24 (see FIGS. 5 and 6). The BIT link may transmit/receive at least the information shown on the six status signal lines and/or additional information, depending on the programming generated and put into the controller 60. The status of battery 24, as determined by the controller 60 program, is output by the controller 60 as shown in FIG. 6. Discrete status outputs are shown, including the BIT serial link that can be used to communicate with, for example, other avionics in the A/V. A full “On” failure, as could be caused by a certain failures of the multiplexer 64, A/D converter 63, controller 60, error detector 61, duty cycle generator 59 or the switcher 47 could cause the alternator to put out full capacity at all times. This could cause an overcharge of the battery 24 and a possible dangerous condition. To mitigate against this, a separate over voltage detector 58 may be incorporated. This provides an independent assessment and if an over voltage situation is detected to exist for some preprogrammed time, the over voltage detector 58 provides a signal to the power switch 45 which causes it to remove excitation to the alternator field, thus reducing the alternator output to zero. A reset limit is also preprogrammed in so that the over voltage detector 58 will be reset and the alternator 42 re-energized as the voltage of battery 24 drops below a certain point, for example, 24 volts for the embodiment shown in FIG. 6.

It is to be understood that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention.

The embodiments illustrated and discussed in this specification are intended only to teach those skilled in the art the best way known to the inventors to make and use the invention. Nothing in this specification should be considered as limiting the scope of the invention. All examples presented are representative and non-limiting. The above-described embodiments of the invention may be modified or varied, without departing from the invention, as appreciated by those skilled in the art in light of the above teachings. It is therefore to be understood that the invention may be practiced otherwise than as specifically described.

We claim:

1. A battery pack comprising:
a lithium battery having a plurality of cells, the lithium battery being connectable to a vehicle voltage bus to filter noise thereon; and
a battery management system coupled to the lithium battery, the battery management system being configured to vary a voltage output of an alternator based on a voltage and/or a current of the lithium battery when the battery pack is connected to the vehicle voltage bus.

2. The battery pack according to claim 1, wherein the battery management system comprises a current sensor configured to measure the current of the lithium battery.

3. The battery pack according to claim 1, wherein the battery management system is configured to measure the voltage of the lithium battery.

4. The battery pack according to claim 1, wherein the alternator has a field winding and the battery management system comprises a switcher configured to vary current through the field winding of the alternator based on the voltage and/or the current of the lithium battery.

5. The battery pack according to claim 4, wherein the battery management system comprises a power switch configured to remove the alternator field current under predetermined conditions.

6. The battery pack according to claim 1, wherein the plurality of lithium cells are coupled in series.

7. The battery pack according to claim 1, wherein the plurality of lithium cells is seven lithium-ion cells coupled in series.

8. The battery pack according to claim 5, wherein the power switch is a MOSFET configured to remove the alternator field current under predetermined conditions.

9. The battery pack according to claim 2, wherein the current sensor is a Hall Effect sensor.

10. The battery pack according to claim 1, wherein the battery unit is adapted to be coupled in parallel on a voltage bus with the alternator and an electronic load.

11. A lithium battery system for providing power to a load comprising:
an alternator; and
a battery pack coupled in parallel with the alternator and the load via a vehicle voltage bus, the battery pack including
a lithium battery comprising a plurality of cells connected to the vehicle voltage bus to filter noise thereon; and
a battery management system coupled to the lithium battery, wherein the battery management system is configured to vary the voltage output of the alternator based on a voltage and/or a current of the lithium battery.

12. The lithium battery system according to claim 11, wherein the battery management system comprises a current sensor configured to measure the current of the lithium battery.

13. The lithium battery system according to claim 11, wherein the battery management system is configured to measure the voltage of the lithium battery.

14. The lithium battery system according to claim 11, wherein alternator includes a field winding and the battery management system comprises a switcher configured to vary a current through the field winding based on the voltage and/or the current of the lithium battery.

15. The lithium battery system according to claim 14, wherein the battery management system comprises a power switch configured to remove the alternator field current under predetermined conditions.

16. The lithium battery system according to claim 11, wherein the plurality of cells are coupled in series.

17. The lithium battery system according to claim 11, wherein the plurality of cells is seven lithium-ion cells coupled in series.

18. The lithium battery system according to claim 15, wherein the power switch is a MOSFET configured to remove the lithium battery from an alternator under predetermined conditions.

19. The lithium battery system according to claim 12, wherein the current sensor is a Hall Effect sensor.

20. A motorized vehicle including the lithium battery system according to claim 11.

21. A method of controlling a lithium battery system including an alternator, a battery pack, and a load, the battery back being coupled in parallel with the alternator and a load via a vehicle voltage bus and including a battery management system coupled to a lithium battery, the method comprising the steps of:
connecting the lithium battery to the vehicle voltage bus to filter noise thereon;
measuring a voltage and/or a current of the lithium battery during charging; and
varying the voltage output of the alternator based on the voltage and/or the current of the lithium battery.
